(19) United States
(12) Patent Application Publication
(10) Pub. No.: US 2023/0276263 A1
(43) Pub. Date: Aug. 31, 2023

(54) MANAGING A WIRELESS DEVICE THAT IS OPERABLE TO CONNECT TO A COMMUNICATION NETWORK

(71) Applicant: Telefonaktiebolaget LM Ericsson (publ), Stockholm (SE)

(72) Inventors: Henrik Rydén, Stockholm (SE); Pablo Soldati, Solna (SE)

(21) Appl. No.: 18/015,978

(22) PCT Filed: Jul. 9, 2021
(86) PCT No.: PCT/EP2021/069149

§ 371 Date: Jan. 13, 2023

Related U.S. Application Data
(60) Provisional application No. 63/050,922, filed on Jul. 13, 2020.

(51) Int. Cl. H04W 24/02; H04W 8/22; H04L 41/16

(52) U.S. Cl. CPC H04W 24/02; H04L 41/16; H04W 8/22

(57) ABSTRACT

A method is disclosed for managing a wireless device that is operable to connect to a communication network. The communication network comprises a RAN, and the wireless device has available for execution multiple ML models each operable to provide an output, on the basis of which at least one RAN operation performed by the wireless device may be configured. The method, performed by the wireless device, comprises determining which of said available ML models should be stored in the wireless device. The method further comprises, in response to determining that at least one of said available ML models should be stored in the wireless device, storing said at least one of said available ML models, and, in response to determining that at least one of said available ML models should not be stored in the wireless device, deleting said at least one of said available ML models.

### TECHNICAL FIELD

The present disclosure relates to methods for managing a wireless device that is operable to connect to a communication network, the methods performed by a Radio Access Network (RAN) node of the communication network, and by the wireless device. The present disclosure also relates to a RAN node for managing a wireless device that is operable to connect to a communication network, a wireless device, and to a computer program product configured, when run on a computer, to carry out methods for managing a wireless device.

### BACKGROUND

Machine Learning (ML) is a branch of Artificial Intelligence (Al), and refers to the use of algorithms and statistical models to perform a task. ML generally involves a training phase, in which algorithms build a computational operation based on some sample input data, and an inference phase, in which the computational operation is used to make predictions or decisions without being explicitly programmed to perform the task. Support for ML in communication networks is an ongoing challenge. The 3^{rd} Generation Partnership Project (3GPP) has proposed a study item on “Radio Access Network (RAN) intelligence (Artificial Intelligence/Machine Learning) applicability and associated use cases (e.g. energy efficiency, RAN optimization), which is enabled by Data Collection″. It is proposed that the study item will investigate how different use cases impact the overall Al framework, including how data is stored across the different network nodes, model deployment, and model supervision. It is anticipated that use of Al will be a key component in future generations of communication networks, including 6^{th} and 7^{th} generation networks. How to deploy such intelligence across a RAN and its connected wireless devices is an open question.

Integrating the use of ML models into existing operational procedures involves several challenges, and there is currently no framework within 3GPP to support the use, at wireless devices, of ML models in the context of RAN operations.

### SUMMARY

It is an aim of the present disclosure to provide methods, a RAN node, a wireless device and a computer readable medium which at least partially address one or more of the challenges mentioned above. It is a further aim of the present disclosure to provide methods, a RAN node, a wireless device and a computer readable medium which cooperate to facilitate the use, by the wireless device, of an ML model in the context of a RAN operation that may be performed by the wireless device.

According to a first aspect of the present disclosure, there is provided a method for managing a wireless device that is operable to connect to a communication network, wherein the communication network comprises a Radio Access Network (RAN). The wireless device has available for execution a plurality of Machine Learning (ML) models that are each operable to provide an output, on the basis of which at least one RAN operation performed by the wireless device may be configured. The method, performed by the wireless device, comprises determining which of said available ML models should be stored in the wireless device. The method also comprises, in response to determining that at least one of said available ML models should be stored in the wireless device, storing said at least one of said available ML models in a first memory in the wireless device. The method also comprises, in response to determining that at least one of said available ML models should not be stored in the wireless device, deleting said at least one of said available ML models from the first memory in the wireless device.

According to another aspect of the present disclosure, there is provided another method for managing a wireless device that is operable to connect to a communication network, wherein the communication network comprises a RAN. The method, performed by a RAN node of the communication network, comprises receiving, from the wireless device, information identifying at least one Machine Learning, ML, model that is operable to provide an output on the basis of which at least one RAN operation performed by the wireless device, said information indicating that said at least one ML model has been deleted from a first memory in the wireless device.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a wireless device that is operable to connect to a communication network, wherein the communication network comprises a RAN. The wireless device has available for execution a plurality of Machine Learning, ML, models that are each operable to provide an output, on the basis of which at least one RAN operation performed by the wireless device may be configured. The wireless device comprises processing circuitry configured to cause the wireless device to determine which of said available ML models should be stored in the wireless device. The processing circuitry is further configured, in response to determining that at least one of said available ML models should be stored in the wireless device, for storing said at least one of said available ML models in a first memory in the wireless device. The processing circuitry is further configured, in response to determining that at least one of said available ML models should not be stored in the wireless device, for deleting said at least one of said available ML models from the first memory in the wireless device.

According to another aspect of the present disclosure, there is provided a RAN node of a communication network comprising a RAN, wherein the RAN node is for managing a wireless device that is operable to connect to the communication network. The RAN node comprises processing circuitry configured to cause the RAN node to receive, from the wireless device, information identifying at least one Machine Learning, ML, model that is operable to provide an output on the basis of which at least one RAN operation performed by the wireless device may be configured, said information indicating that said at least one ML model has been deleted from a first memory in the wireless device.

Aspects of the present disclosure thus provide a framework for allowing a wireless device to manage the ML models that it stores. This allows the wireless device to store only the most relevant ML models, or those that produce the greatest improvement in performance of the wireless device. This in turn allows the amount of data that must be transmitted to the wireless device to be reduced, and thus reduces network traffic and improves battery life of the wireless device. Also, storing only the most relevant models enables the wireless device to access, and therefore use, said models more quickly when needed. The transmission of the information to the network node also enables the network to update models, based on information received from the wireless device about models that have been deleted, and this can be used to improve the overall model efficiency, for example to trade-off the model size with the performance.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, “model parameters”, “model information”, etc., may thus be understood as relating to any one or more of the above concepts encompassed within the scope of “ML model”.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method performed by a wireless device for managing the wireless device;

FIGS. 2a, 2b and 2c form a flow chart illustrating process steps in another example of a method performed by a wireless device for managing the wireless device;

FIG. 3 is a flow chart illustrating process steps in a method performed by a RAN node for managing a wireless device;

FIG. 4 is a flow chart illustrating process steps in another example of a method performed by a RAN node for managing a wireless device;

FIG. 5 illustrates a first use of an ML model;

FIG. 6 further illustrates the first use of an ML model;

FIG. 7 further illustrates the first use of an ML model;

FIG. 8 illustrates a second use of an ML model;

FIG. 9 illustrates an example autoencoder for CSI compression;

FIG. 10 illustrates a second use of an ML model;

FIG. 11 is a block diagram illustrating functional modules in a wireless device;

FIG. 12 is a block diagram illustrating functional modules in another example of a wireless device;

FIG. 13 is a block diagram illustrating functional modules in a RAN node;

FIG. 14 is a block diagram illustrating functional modules in another example of a RAN node; and

FIG. 15 is a signalling diagram illustrating an example signalling exchange.

### DETAILED DESCRIPTION

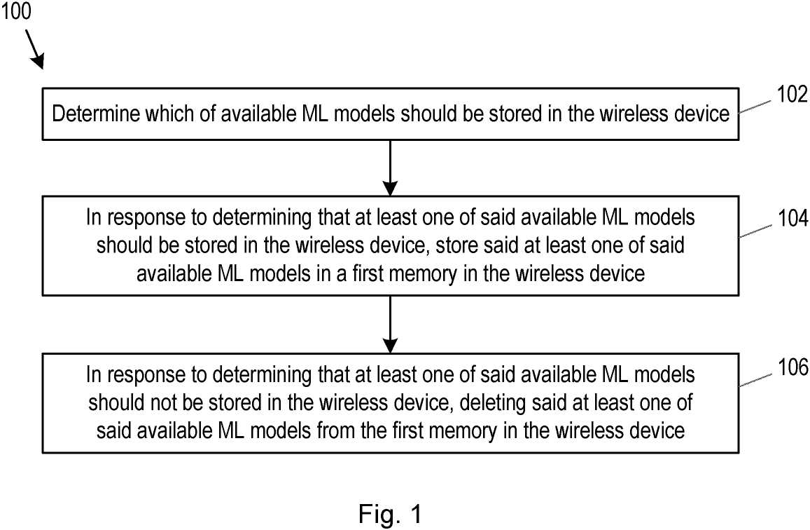

FIG. 1 is a flow chart illustrating process steps in a method 100 performed by a wireless device for managing the wireless device. The wireless device may for example comprise a User Equipment device in a cellular communication network.

The wireless device is operable to connect to a communication network, wherein the communication network comprises a Radio Access Network, RAN, and the wireless device has available for execution a plurality of Machine Learning, ML, models that are each operable to provide an output, on the basis of which at least one RAN operation performed by the wireless device may be configured.

The RAN operation performed by the wireless device, which operation may be configured on the basis of an output of the ML model, may be configured by the wireless device itself or by a node of the communication network. A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations may include Handover, secondary carrier prediction, geolocation, signal quality prediction, beam measurement and beamforming, traffic prediction, Uplink synchronisation, channel state information compression, wireless signal reception/transmission, etc. Any one of more of these example operations or operation types may be configured on the basis of an output of an ML model. For example, the ML model may predict certain measurements, on the basis of which decisions for RAN operations may be taken. Such measurements may be used by the wireless device and/or provided to the RAN node to which the wireless device is connected. In further examples, the timing or triggering of a RAN operation may be based upon a prediction output by an ML model.

The method, performed by the wireless device, comprises step 102, of determining which of said available ML models should be stored in the wireless device. The method further comprises, in response to determining that at least one of said available ML models should be stored in the wireless device, step 104, namely storing said at least one of said available ML models in a first memory in the wireless device. The method further comprises, in response to determining that at least one of said available ML models should not be stored in the wireless device, step 106, namely deleting said at least one of said available ML models from the first memory in the wireless device.

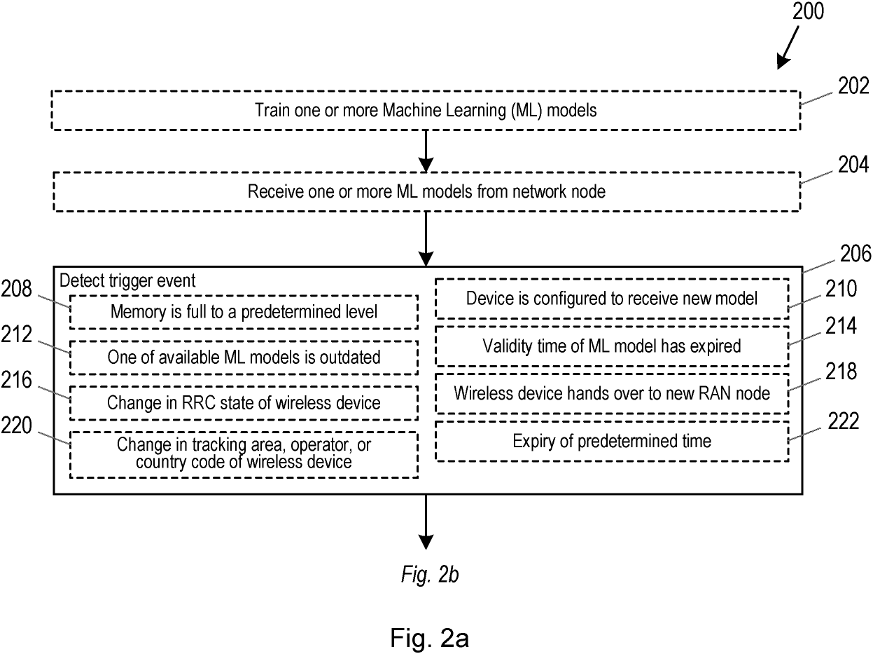

FIGS. 2a, 2b and 2c form a flow chart illustrating process steps in a further method 200 performed by a wireless device for managing the wireless device. The wireless device may for example comprise a User Equipment device in a cellular communication network.

It will be appreciated that the steps of the method 200 may be performed in a different order to that presented below, and may be interspersed with actions executed as part of other procedures being performed concurrently by the wireless device.

The wireless device is operable to connect to a communication network, wherein the communication network comprises a Radio Access Network, RAN.

At step 202, the wireless device may train one or more Machine Learning, ML, models that are each operable to provide an output, on the basis of which at least one RAN operation performed by the wireless device may be configured. Specifically, the wireless device may train the or each model based on data that is located at the device.

At step 204, the wireless device may receive one or more ML models from a network node. Again, the ML models are each operable to provide an output, on the basis of which at least one RAN operation performed by the wireless device may be configured.

When the wireless device receives an ML model from a network node, it may decide to reject that model immediately. This decision may be based on historical information. As discussed in more detail below, a wireless device may decide to delete a ML model from its memory. If the wireless device decides to delete a model due to low performance, the wireless device can select or request to not download it, if it is configured to download it on a future occasion. This could allow the wireless device to download only relevant models, or to avoid downloading models that it will anyway delete.

Thus, the wireless device has available for execution a plurality of ML models that are each operable to provide an output, on the basis of which at least one RAN operation performed by the wireless device may be configured. The available ML models may include one or more models trained in the wireless device and/or may include one or more models received from a network node.

Examples of operations that may be executed by the wireless device with a machine learning model may comprise one or more operations in the group of:
power control in Uplink (UL) transmission
Link adaptation in UL transmission, such as selection of modulation and coding scheme
Estimation of channel quality or other performance metrics, such as
   radio channel estimation in uplink and downlink,
   channel quality indicator (CQI) estimation/selection,
   signal to noise estimation for uplink and downlink,
   signal to noise and interference estimation,
   reference signal received power (RSRP) estimation,
   reference signal received quality (RSRQ) estimation, etc.
Information compression for UL transmission
Coverage estimation for secondary carrier
Estimation of signal quality/strength degradation
Mobility related operations, such as cell reselection and handover trigger
Energy saving operations

At step 206, the wireless device detects a trigger event, which causes it to determine which of said available ML models should be stored in the wireless device.

For example, as shown at 208, the trigger event may be a determination that a first memory of the wireless device is full to a predetermined level. As another example, as shown at 210, the trigger event may be that the wireless device is configured to receive a new model. As another example, as shown at 212, the trigger event may be the wireless device receiving an indication that one of the available ML models is outdated. For example, this could occur if the model identifier for a certain radio network operation has changed. This could be detected when the network intends to configure a new model of a certain radio network operation that is already using an ML model. The UE can then delete the old model in response to this.

As another example, as shown at 214, the trigger event may be the wireless device determining that a validity time associated with one of said available ML models has expired. The model may for example be configured with a certain time period for which it will be valid.

As another example, as shown at 216, the trigger event may be a change in a Radio Resource Control, RRC, state of the wireless device. For example, this change in the RRC state of the wireless device might involve the wireless device going into inactive/idle mode.

As another example, as shown at 218, the trigger event may be that the wireless device hands over to a new RAN node. As another example, as shown at 220, the trigger event may be a change in a tracking area, operator, or country code of the wireless device. As another example, as shown at 222, the trigger event may be an expiry of a predetermined time, such that the determination as to which of said available ML models should be stored in the wireless device is made at periodical time intervals.

In response to detecting the trigger event, the method passes to step 230, as shown in FIG. 2b.

In step 230, the wireless device determines which of the available ML models should be stored in the wireless device. For example, the wireless device may determine which of the available ML models are most relevant for its future operation. Reducing the amount of memory used for storing ML models allows stored models to be retrieved more quickly when they are to be used.

As is known, one or more of the available ML models may be a tree-based model. In that case, as shown at 232, the step of determining which of the available ML models should be stored in the wireless device may comprise determining which part or parts of any tree-based model should be stored in the wireless device.

The determination of step 230 may be made based on one or more factor.

For example, as shown at 234, the method may involve determining which of said available ML models should be stored in the wireless device based on a number of times that the wireless device has been in a specific area of the RAN. For example, this may include being connected to a specific call of the RAN. If a model is particularly useful when used in a specific cell, the decision on whether or not to store that model may depend on how often the wireless device has been connected to that specific cell.

Alternatively or additionally, as shown at 236, the method may involve determining whether a specific one of said available ML models should be stored in the wireless device based on a number of times that the wireless device has been configured to use said specific one of said available ML models.

For example, the method may involve deciding to store any ML model that has been used by the wireless device more than a threshold number of times. The threshold number can depend on the memory available at the device, and/or the type of models, and/or the memory requirements of the models to be stored, and/or the computational complexity of the models to be stored, and/or the energy consumption required to execute the models, and/or the expected performance improvement expected from the models.

Alternatively or additionally, as shown at 238, the step 230 of determining which of said available ML models should be stored in the wireless device may comprise selecting a number of said available ML models that the wireless device has been configured to use most often.

Specifically, the method may involve deciding to store a predetermined number of the most often used ML models. The predetermined number can depend on the memory available at the device, and/or the type of models, and/or the memory requirements of the models to be stored, and/or the computational complexity of the models to be stored, and/or the energy consumption required to execute the models, and/or the expected performance improvement expected from the models. Alternatively, since different models of different complexity have different memory requirements, the method may involve storing a number of models, where the number is dependent on what models have been stored and on the memory requirements of the stored models.

Alternatively or additionally, as shown at 240, the method may involve determining which of said available ML models should be stored in the wireless device based on a geographical location of the wireless device. For example, when deciding which models to store and/or delete, the wireless device may take account of its current geographical location in relation to the geographical locations at which it has previously used the models and/or the geographical locations at which it has downloaded the models.

Alternatively or additionally, as shown at 242, the method may involve determining which of said available ML models should be stored in the wireless device based on a radio location of the wireless device. The radio location may be expressed in terms of one or more of a Physical/global cell id(s), a Beam ID, a tracking area code, a country area code, and a location area. When deciding which models to store and/or delete, the wireless device may take account of its current radio location in relation to the radio locations at which it has previously used the models and/or the radio locations at which it has downloaded the models.

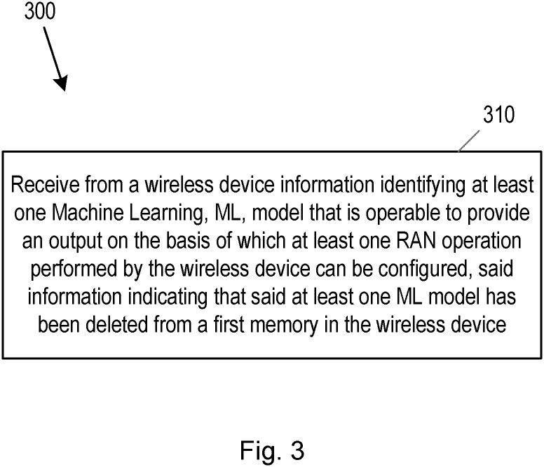

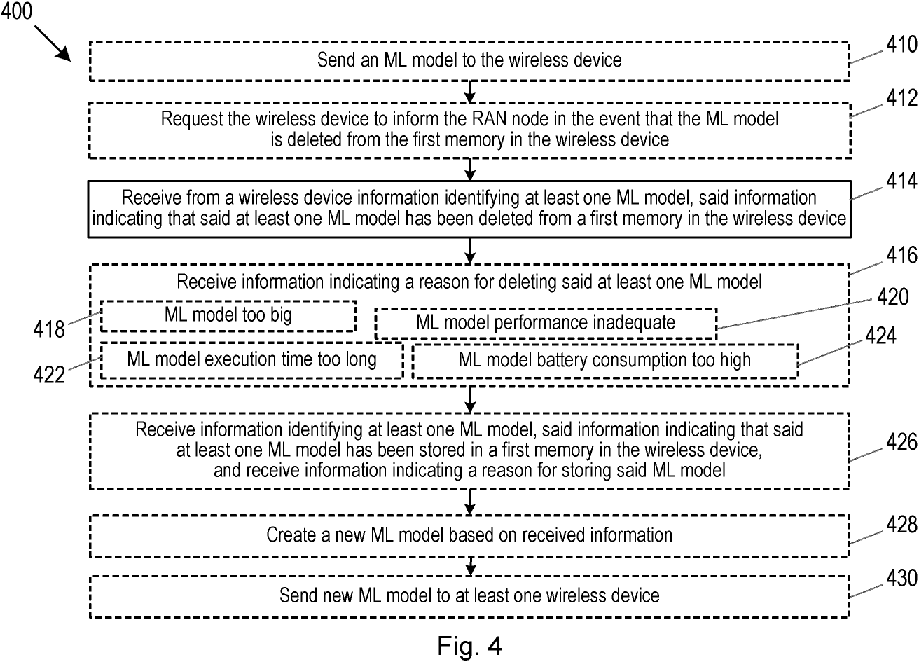

The determination of step 230 may also be made based on the radio network operation that the models are concerned with. For example, models related to inter-frequency prediction (as described with reference to FIGS. 5, 6 and 7 above) get outdated whenever the radio environment changes, for example due to new base station deployment, or sleeping cells, or antenna tilt changes. The wireless device can therefore select to delete all models related to inter-frequency prediction if one of the models in a certain area has changed. For example, in the situation shown in FIG. 6, if the model relating to the coverage area 612 has changed, then most likely the model relating to the neighbouring coverage area 622 has also changed its model, and so the wireless device can also delete the model relating to the coverage area 622.

The determination of step 230 may also be made based on the radio network operation improvement that a given ML model produces. For example, the wireless device can in one embodiment select which model to keep based on an estimate of the improvement that is obtained by using certain ML models for a certain radio network operation. For example, the wireless device can compare the improvements experienced with a ML based link-adaptor with the improvements of an ML based beamforming system. The comparison can be made by turning off and on the ML-based approach, and comparing the throughput while using and not using the ML model.

After performing step 230, the method passes to FIG. 2c. Step 230 may result in a determination that at least one of the available ML models should be stored a first memory in the wireless device, or at least should not be deleted from the memory of the wireless device, and may also result in a determination that at least one of the available ML models should not be stored the first memory in the wireless device, or should be deleted from the memory of the wireless device.

In response to determining that at least one of said available ML models should be stored in the wireless device, the method passes to step 250, in which said at least one of said available ML models is stored in a first memory in the wireless device.

The first memory may for example be cache memory, Random-access memory (RAM), or a hard disk drive (HDD).

The method may then further comprise step 252, of transmitting to at least one RAN node information identifying said at least one of said available ML models stored in the first memory in the wireless device.

The method may further comprise step 254, of transmitting to the at least one RAN node information indicating a reason for storing said at least one of said available ML models in the first memory in the wireless device.

The method may then further comprise step 256, of eventually applying or using the stored ML model at the appropriate time. As mentioned above, applying or using the stored ML model may comprise configuring a RAN operation performed by the wireless device on the basis of an output of the ML model, or basing the timing or triggering of a RAN operation based upon a prediction output by the ML model.

In response to determining that at least one of said available ML models should not be stored in the wireless device, the method passes to step 260, in which at least one of said available ML models is deleted from the first memory in the wireless device, or is not stored in the first memory.

The method may then further comprise step 262, of transmitting to at least one RAN node information identifying said at least one of said available ML models deleted from the first memory in the wireless device.

The method may further comprise step 264, of transmitting to the at least one RAN node information indicating a reason for deleting said at least one of said available ML models from the first memory in the wireless device.

The reason for deleting said at least one of said available ML models from the first memory in the wireless device may for example be:
that the ML model is too big, as shown at 266;
that the ML model performance is inadequate, as shown at 268;
that the ML model execution time is too long, as shown at 270; and/or
that the ML model battery consumption is too high, as shown at 272.

The method may further comprise transmitting to the at least one RAN node information indicating the radio features associated with the one or more deleted ML models.

The method may further comprise step 274 of, in response to determining that at least one of said available ML models should not be stored in the wireless device, storing said at least one of said available ML models in a second memory of the wireless device separate from the first memory of the wireless device.

Thus, in such embodiments, if a decision is taken that the model should not be stored in the first memory (i.e. a memory from which it can be most readily accessed when required), it is not deleted, but instead is moved between different memory entities. For example, the model may be moved from the cache-memory of the wireless device to a Random-access memory (RAM) of the wireless device. As another example, it can be moved from RAM to a hard disk drive (HDD).

In general, loading from RAM is much faster than loading models from the HDD, and so the wireless device therefore risks a longer execution time for models stored in the HDD, in comparison to models stored in cache-memory. Thus, in this case, the decision not to store the model in the first memory can be made based on the factors mentioned above (such as the number of times the model has been used), but can also be made based on the execution time constraints of the model, taking account of the time from when it is determined or configured that the model should be used, to get a model output.

The method may further comprise step 276 of informing other wireless devices about the deletion of the ML model.

For example, the wireless device might signal to other wireless devices (and in particular to other wireless devices with similar capabilities to its own) that it has deleted the model. The wireless device might also indicate a new model that the wireless device will use to replace the deleted model. The wireless device might also indicate the reason(s) for the deletion, allowing the other wireless devices to make their own decisions on whether or not to delete the model based on this information. The wireless device might signal this information directly to other wireless devices, or might signal the information through the radio access network, or through one or more core network node that is responsible for mobility management.

In some examples (not shown), the method 200 may further comprise receiving from a RAN node an indication that the wireless device may delete at least one of the available ML models, and deleting the at least one of the ML models in response to the received indication. The indication may in some examples comprise an instruction to delete the relevant ML model or models, or may simply comprise an indication that the wireless device may delete the ML model or models. This indication may be taken into account by the wireless device in determining whether or not to delete any of the ML models available to it for execution.

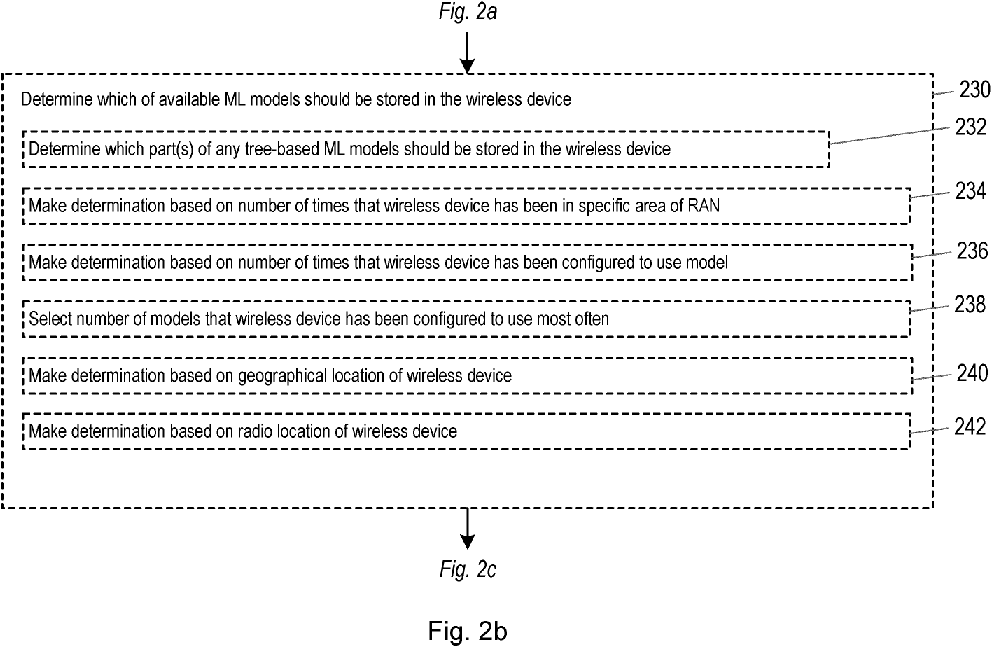

FIG. 3 is a flow chart illustrating a process step in a method 300 for managing a wireless device that is operable to connect to a communication network, wherein the communication network comprises a Radio Access Network (RAN). The method is performed by a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a base station node such as a NodeB, eNodeB, gNodeB, or any future implementation of the above discussion functionality. Referring to FIG. 3, the method 300 comprises, in step 310, receiving, from the wireless device, information identifying at least one Machine Learning, ML, model that is operable to provide an output on the basis of which at least one RAN operation performed by the wireless device may be configured, said information indicating that said at least one ML model has been deleted from a first memory in the wireless device.

The RAN operation performed by the wireless device, which operation may be configured on the basis of an output of the ML model, may be configured by the wireless device itself or by a node of the communication network, which may be the RAN node performing the method 300. A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations may include Handover, secondary carrier prediction, geolocation, signal quality prediction, beam measurement and beamforming, traffic prediction, Uplink synchronisation, channel state information compression, wireless signal reception/transmission, etc. Any one of more of these example operations or operation types may be configured on the basis of an output of an ML model. For example, the ML model may predict certain measurements, on the basis of which decisions for RAN operations may be taken. Such measurements may be used by the wireless device and/or provided to the RAN node performing the method 300. In further examples, the timing or triggering of a RAN operation may be based upon a prediction output by an ML model.

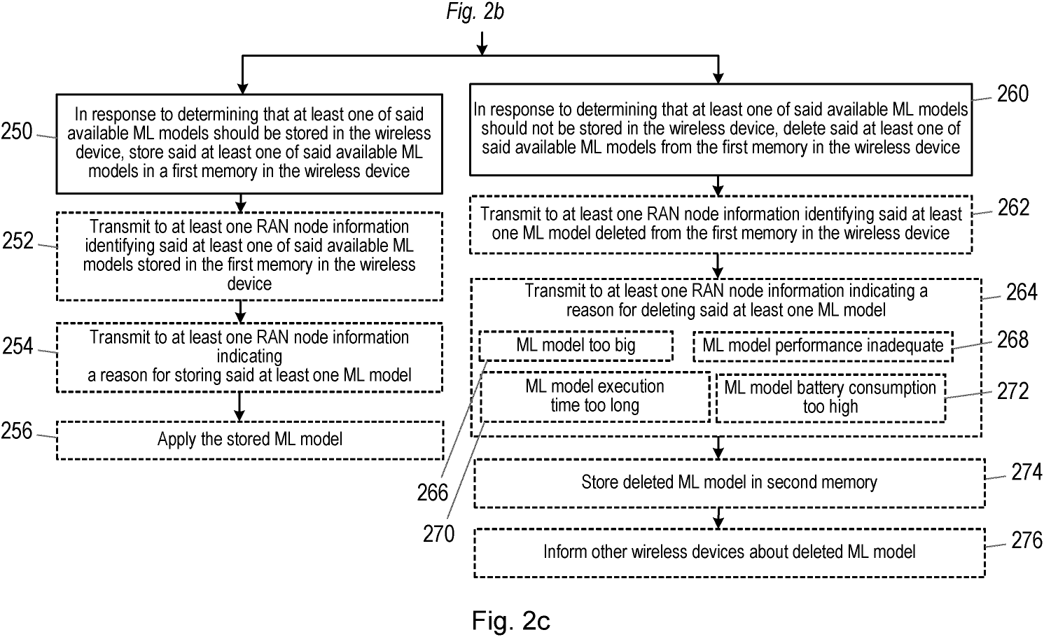

FIG. 4 is a flow chart illustrating process steps in a further method 400 for managing a wireless device that is operable to connect to a communication network, wherein the communication network comprises a Radio Access Network (RAN). The method is performed by a RAN node of the communication network. It will be appreciated that the steps of the method 400 may be performed in a different order to that presented below, and may be interspersed with actions executed as part of other procedures being performed concurrently by the RAN node.

The method 400 starts with step 410, namely the RAN node sending a Machine Learning, ML, model to the wireless device. The ML model may be operable to provide an output on the basis of which at least one RAN operation performed by the wireless device can be configured, as described in more detail with reference to FIG. 3. In step 412, the RAN node requests the wireless device to inform the RAN node in the event that the ML model is deleted from the first memory in the wireless device. The RAN node may also request the wireless device to inform the RAN node in the event that any ML model, including an ML model trained in the wireless device itself, is deleted from the first memory in the wireless device.

In step 414, the RAN node receives, from the wireless device, information identifying at least one ML model, where the information indicates that said at least one ML model has been deleted from a first memory in the wireless device. The identified ML model may be a model that was sent by the RAN node to the wireless device, or may be an ML model trained by the wireless device.

In step 416, the RAN node receives from the wireless device information indicating a reason for deleting said at least one ML model from the first memory in the wireless device.

The reason for deleting said at least one of said available ML models from the first memory in the wireless device may for example be:
that the ML model is too big, as shown at 418;
that the ML model performance is inadequate, as shown at 420;
that the ML model execution time is too long, as shown at 422; and/or
that the ML model battery consumption is too high, as shown at 424.

The network may be configured with valid deletion information events, allowing the wireless device to efficiently signal deletion information to the RAN node.

In step 426, the RAN node may also receive from the wireless device information identifying at least one ML model, where the information indicates that said at least one ML model has been stored in the first memory in the wireless device. The information may also include information indicating a reason for storing said at least one ML model in the first memory in the wireless device.

In step 428, in response to receiving information identifying at least one ML model that has been deleted from the first memory in the wireless device, the RAN node creates a new and/or updated ML model based on the received information. For example, the RAN node may create a new ML model that attempts to overcome the stated reason for deleting the ML model from memory in the wireless device. For example, if the stated reason for deleting the model was that the model is too big for the limited performance gain that it produces, the RAN node may generate a new ML model with lower memory requirements.

As another example, in the case of the example of secondary carrier prediction, described with reference to FIGS. 5, 6 and 7, the wireless device may indicate that the predicted coverage measurements on the other carrier have not corresponded to the experienced quality after the UE moved to that other carrier. If so, the wireless device can switch to a fallback procedure, without using measurement prediction on that carrier.

Such a situation can trigger the network to train a new model for the radio operation, possibly by first collecting new data for training the model.

Step 428 may involve creating a new ML model if it is informed that multiple wireless devices, for example more than a threshold number of wireless devices, have deleted a particular ML model.

In addition, in response to receiving information identifying at least one ML model that has been deleted from the first memory in the wireless device, the RAN node may decide that it should not attempt to download the same model again to the same wireless device. Further, the RAN node may decide that it should not attempt to download the same model to a second wireless device with similar characteristics (for example a device of the same type, such as an loT device, a smartphone, a drone, or a vehicular device, or a device having the same manufacturer or model number) to the wireless device that signalled the model deletion.

In one embodiment, the network collects a set of deletion information reports from multiple wireless devices. Based on the set of reports, the network trains and updates the model. For example, if more than a threshold number of users have deleted the model because it is too big, the network may train a smaller model, for example by reducing the number of layers, or neurons per layer in case of a neural network.

This allows the RAN node to generate updated and improved models, based on feedback from the wireless devices.

In step 430, in the event that a new model is created, the RAN node, sends the new ML model to the wireless device.

In some examples (not shown), the method 400 may further comprise sending to the wireless device an indication that the wireless device may delete at least one ML model available for execution by the wireless device. The indication may in some examples comprise an instruction to delete the relevant ML model or models, or may simply comprise an indication that the wireless device may delete the ML model or models. In some examples, the RAN node may send the indication in response to determining, at the RAN node, that the ML model or models is/are suitable for deletion, for example as a consequence of a physical or radio location of the wireless device, or owing to the models being out of date or in some other manner unsuitable for use by the wireless device. The RAN node may determine that the ML model or models is/are suitable for deletion as a consequence of any of the factors discussed above with respect to determining, at the wireless device, which one or more ML models should be deleted by the wireless device.

The methods 100, 200, 300 and 400 illustrate how a RAN node and wireless device may cooperate to support the deployment of ML models that are available for execution by a wireless device in support of RAN operations.

The ML models of that are the subject of the present disclosure are primarily models that are operable to provide an output on the basis of which a RAN operation performed by a wireless device may be configured. Examples of RAN operations performed by a wireless device that could be executed in accordance with an output of an ML model according to the present disclosure are presented below. The following discussion divides the example RAN operations into those which are both trained and executed by the wireless device (referred to in the following discussion as a User Equipment or UE), and those which are trained by a node of the communication network of which the RAN is a part, and subsequently downloaded to a wireless device for execution.

ML model trained and executed by UE

Some AI/ML capable UEs are able to build intelligence that can be used to improve the radio network operation, as in the following examples:

### Example 1: Lower Latency via Traffic Prediction

In delay critical applications it is important not to lose Uplink synchronisation immediately before or during arrival of data, as synchronising the Uplink prior to Uplink transmission increases delay. One solution to this issue is to force a UE to perform synchronisation if no Uplink transmission has taken place within a certain time window. However, this can lead to a large increase of signalling and interference related to unnecessary uplink synchronisation. A UE could instead predict data arrival using an ML model, and consequently ensure that Uplink synchronisation is completed before the predicted data arrival. The traffic experienced by one UE can be used to train a model that predicts when synchronisation, or in general when Uplink resources may be required. A UE could for example send a scheduling request if traffic is expected based on executed ML model, and so reduce its latency. In such examples, the RAN operation that may be configured on the basis of an output of the ML model would be Uplink synchronisation, and its configuration would be the timing of the synchronisation, to coordinate with traffic predictions provided by the model.

### Example 2: Mobility Prediction

UEs typically move along similar trajectories each day, representing daily or weekly movement patterns of users. Instead of measuring signal strengths of neighbouring cells, a UE could therefore use its geo-location as input to predict the signal strength of a particular reference signal (for example the 5^{th} generation 3GPP Synchronisation Signal Block (SSB) for a radio base station). The predicted signal strength can then be used to trigger different events, such as a handover decision. In this example, the RAN operation that may be configured on the basis of an output of the ML model would be handover, and its configuration would be the timing of the handover decision, on the basis of predicted signal strength from the ML model.

### Example 3: Beam Management

A UE may use an ML model to reduce its measurement requirements related to beamforming. In the RAN of a 5th Generation 3GPP network, referred to as New Radio (NR), it is possible to request a wireless device such as a UE to perform measurements on a set of Channel State Information Reference Signal (CSI-RS) beams. A stationary UE may experience a static environment and consequently minimal change in beam quality. The UE can therefore save battery by reducing beam measurements: using an ML model to predict beam strength instead of measuring it. A UE may for example measure a subset of beams and use an ML model to predict measurements for remaining beams.

ML model trained by communication network and signalled to UE for execution

Several use cases may benefit from training an ML model at the communication network, and then signalling the model to a wireless device for execution.

### Example 4: Secondary Carrier Prediction

In order to detect a node on another frequency using target carrier prediction, a UE is conventionally required to perform signalling of source carrier information. For example a mobile UE may periodically transmit source carrier information in order to enable a macro node to handover the UE to another node operating at a higher frequency. Using target carrier prediction, the UE does not need to perform inter-frequency measurements, leading to energy savings at the UE. Frequent signalling of source carrier information that would enable predicting the secondary frequency can lead to an additional overhead and should thus be minimized. However, there is a risk that if frequent periodic signalling is not performed, an opportunity for inter-frequency handover to a less-loaded cell on another carrier may be missed. For example, if the reporting periodicity is too high, the UE may not report any source carrier measurement when inside the coverage region of a less loaded cell.

This is illustrated in FIG. 5, which shows a UE moving from a first position 510 to a second position 520, within the coverage area of a network node 530 on frequency 1. As the UE moves towards a network node 532 on frequency 2, it might be advantageous to handover to the network node on frequency 2.

According to examples of the present disclosure, the UE could be configured with an ML model by the network node 530, and use source carrier information as input to the model, which then generates an output indicating whether there is coverage on the less loaded cell on frequency 2. When this output indicates that there is coverage on the less loaded cell, this triggers a report 534 from the UE to the network node 530, which can then decide on a possible handover. This reduces the need for frequent source carrier information signalling, while enabling the UE to predict the coverage on the target cell.

FIG. 6 shows an example of this source carrier prediction in multiple cells.

Specifically, FIG. 6 shows a UE moving from a first position 610, within the coverage area 612 of a first network node 614 on frequency 1, to a second position 620, within the coverage area 622 of a second network node 624 on frequency 1, and to a third position 630, within the coverage area 632 of a third network node 634 on frequency 1. The coverage area 612 of the first network node 614 also includes a fourth network node 616 on frequency 2; the coverage area 622 of the second network node 624 also includes a fifth network node 626 on frequency 2; and the coverage area 632 of the third network node 634 also includes a sixth network node 636 on frequency 2.

As described above, a ML model can be signalled to a wireless device in order to improve radio network operations, for example to improve the inter-frequency handover procedure at the device. Thus, downloading models to the device can enable the UE to perform and assist in radio network operations. However, each model might only be limited to a certain area. Thus, in the case illustrated in FIG. 6, the network node 614 might signal to the UE a model that indicates the relationship between frequency 1 and frequency 2 in the coverage area 612, but the network node 624 might have a different model that indicates the relationship between frequency 1 and frequency 2 in its coverage area 622, and the network node 634 might have a different model again that indicates the relationship between frequency 1 and frequency 2 in its coverage area 632. Thus, the UE needs to receive a new model whenever it enters another radio area (e.g. connects to a new base station).

This can lead to a lot of model signalling, and one method to reduce the signalling is to store the received models at the device, and use the stored models when the UE reconnects to a previous radio cell. The models that are stored in the device can be reported to the network. However, the constrained hardware requirements of the device will limit the number of models that can be stored at the device. Thus, there is a trade-off between over-the-air signalling of models and the storing overhead of models at the device. Since the cost/complexity of the device is proportional to the memory needed at the device, one would like to keep the needed memory at a minimum.

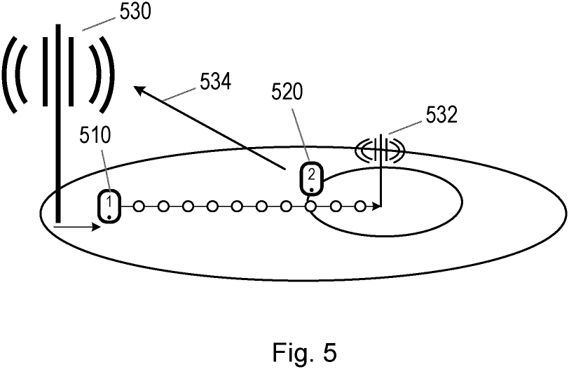

FIG. 7 illustrates a situation similar to FIG. 6, in which the methods of FIGS. 1, 2, 3 and 4 may be used, by way of a very simple illustration of the operation of those methods.

Specifically, FIG. 7 shows a UE 700 in an area that contains the coverage area 712 of a first network node 714 on frequency 1, the coverage area 722 of a second network node 724 on frequency 1, and the coverage area 732 of a third network node 734 on frequency 1. The coverage area 712 of the first network node 714 also includes a fourth network node 716 on frequency 2; the coverage area 722 of the second network node 724 also includes a fifth network node 726 on frequency 2; and the coverage area 732 of the third network node 734 also includes a sixth network node 736 on frequency 2.

On a first journey, shown by arrow 750, when the UE 700 enters the coverage area 712, the UE 700 receives from the network node 714 an ML model that expresses the relationship between the coverage on frequency 1 and on frequency 2 within the coverage area 712. The UE 700 can then store this ML model, and use it while it is in the coverage area 712.

Then, when the UE 700 enters the coverage area 722, the UE 700 receives from the network node 724 an ML model that expresses the relationship between the coverage on frequency 1 and on frequency 2 within the coverage area 722. The UE 700 can then store this ML model, and use it while it is in the coverage area 722.

On a second journey, shown by arrow 760, when the UE 700 enters the coverage area 712, it is able to use the previously received ML model that expresses the relationship between the coverage on frequency 1 and on frequency 2 within the coverage area 712.

Then, when the UE 700 enters the coverage area 732, the UE 700 receives from the network node 734 an ML model that expresses the relationship between the coverage on frequency 1 and on frequency 2 within the coverage area 732.

However, if we assume that the UE 700 is unable to store more than two ML models, it is not able to store the model that receives from the network node 734, in addition to the previously stored ML models that it received from the network nodes 714 and 724. Specifically, if it wishes to download and use the model from the network node 734, it must choose to delete one of the previously stored ML models that it received from the network nodes 714 and 724.

In this simple example, the UE is configured to store the models that it has used most often in the past. Since it has used the model that it received from the network node 714 twice, and has only used the model that it received from the network node 724 once, it determined that the model that it received from the network node 724 should be deleted.

The UE 700 can then store the newly received ML model, and use it while it is in the coverage area 732.

If the UE 700 notifies the network that it has deleted the model that it received from the network node 724, the network will then know which models the UE is able to use.

### Example 5: Privacy-Conserving Use of Geo-Location

UE location may be used to predict conditions on possible alternative network nodes that the UE could connect to. In the case of an ML model that is trained at the network, the necessary transfer of data may give rise to privacy concerns, and federated learning may therefore be used, as discussed in a non-published reference document.

### Example 6: Signal Quality Drop Prediction

Based on received UE data from measurement reports, the network can learn for example what sequences of signal quality measurements (e.g. the Reference Signal Received Power, RSRP) result in a large signal quality drop, for example when turning around a corner.

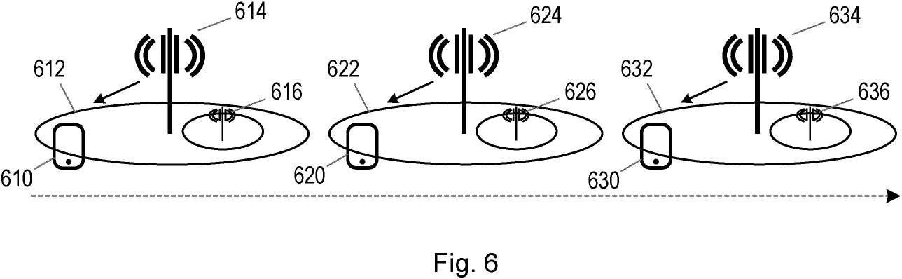

FIG. 8 shows an example of this, where a first UE follows the path 810 shown in (a) by the solid line, and its measured signal quality, for example reported RSRP data, is shown in (b) by the solid line 820.

The data represented by the line 820 within the window 830 can be treated as training data for a model, allowing a signal quality to be predicted when a UE leaves the training window.

Thus, for example, when the first UE turns the sharp corner at 812 in (a), it experiences a sharp fall in RSRP, as shown at 822 in (b).

The learning can be done by feeding RSRP values at times t1, ..., tn into a machine learning model (for example a Neural network), and then predict the RSRP values at subsequent time tn+1,tn+2, etc. After the model is trained, the network can download the model to the UE, that then predicts future signal quality values.

Thus, when a second UE follows the path 814 shown in (a) by the dashed line, and its measured signal quality, for example reported RSRP data, is shown in (b) by the dashed line 824, it can use the ML model to predict future values of RSRP.

Since the RSRP data of the second UE, shown in (b) by the dashed line 824, closely follow the RSRP data of the first UE, shown in (b) by the solid line 820, the ML model can predict that the RSRP data of the second UE, when it leaves the training window 830, will continue to follow the RSRP data of the first UE.

The ML model can thus predict that the second UE will suffer a significant fall in RSRP in the same way that the first UE did. This allows the effect of that fall in RSRP to be mitigated.

For example, the predicted future signal quality values can be used to: initiate an inter-frequency handover; set handover and/or reselection parameters; and/or change the UE scheduler priority, for example scheduling the second UE at a time when the expected signal quality is good.

### Example 7: Compression of Channel State Information (CSI)

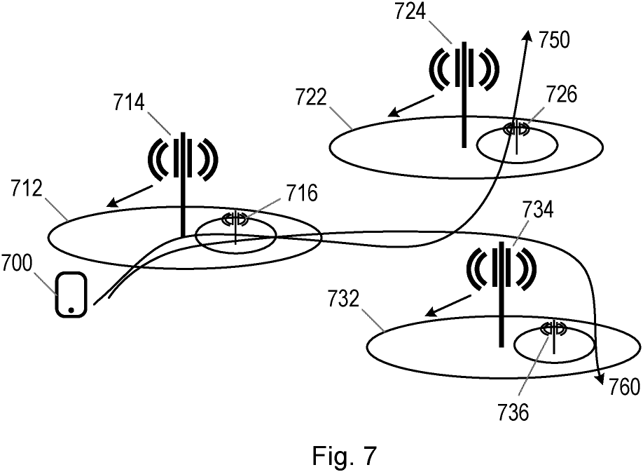

It has been proposed in a non-published reference document to use Autoencoders to compress CSI for enhanced beamforming. An autoencoder is a type of machine learning algorithm that may be used to learn efficient data representations, that is to concentrate data. Autoencoders are trained to take a set of input features and reduce the dimensionality of the input features, with minimal information loss. An autoencoder is divided into two parts, an encoding part or encoder and a decoding part or decoder. The encoder and decoder may comprise, for example, deep neural networks comprising layers of neurons. An encoder successfully encodes or compresses the data if the decoder is able to restore the original data stream with a tolerable loss of data. One example of an autoencoder comprising an encoder/decoder for CSI compression is illustrated in FIG. 9. At the UE, the measured absolute values 902 of the Channel Impulse Response (CIR) are input to the encoder part 904 to be compressed to a code. This code is reported to a radio network node, which uses a corresponding decoder part 906 of the autoencoder to reconstruct the measured CIR 908. The radio node may then perform beamforming based on the decoded code (CIR).

In a further proposal, the methods described above may be developed for compressing a channel in order to improve the Observed Time Difference of Arrival (OTDOA) positioning accuracy in a multipath environment. OTDOA is one of the positioning methods introduced for Long Term Evolution (LTE) networks in 3GPP specification Release 9. The richer channel information provided by OTDOA can enable the network to test multiple hypotheses for position estimation at the network side, which increases the potential for a more accurate position estimation. For channel compression, the encoder part of the autoencoder, once trained at the network, is signalled for execution to the UE.

### Example 8: Encoding/Decoding of Wireless Signals

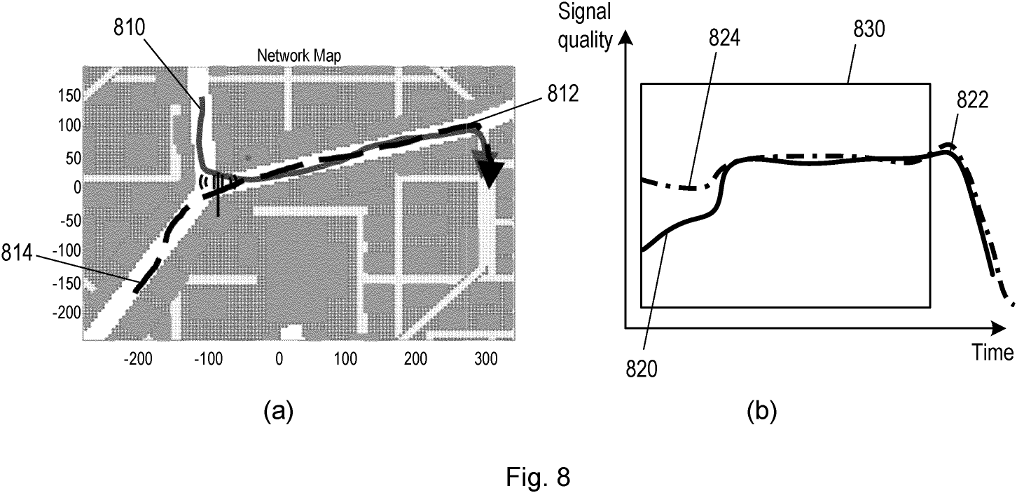

In future generations of wireless networks, it is anticipated that an ML model may be used to encode/decode wireless signals directly. This is in contrast to existing systems, such as 5^{th} generation NR, in which steps in the receiver chain including source decoder, channel decoder and de-modulator (analog to digital) are specified. The existing building blocks for the receiver chain, or parts of the existing building blocks, could be replaced with an ML model. This replacement would allow joint optimisation, enabling sharing of information across different layers, and so achieving higher flexibility and reducing the handcrafted design of each block. The high-level overview of such procedure is illustrated in FIG. 10.

Referring to FIG. 10, a wireless device can receive from a radio network node a receiver model detailing how to process a received wireless signal y, or a transmitter model detailing how to generate a wireless signal x, in order to transmit the device’s data symbols s. Feedback in the form of information on the ML model performance can be signalled via a second communication channel, such as NR RRC protocol, or LTE, or Wifi. This feedback can be used to improve the ML model. The model or models can be sent to the device over the same second communication channel. In this example (e.g. using NR SIB/RRC), the first communication channel is used to transmit data to the device, while the second communication channel provides the control information (for example the models used in the first communication channel).

The above examples demonstrate some of the use cases in which ML models may support RAN operations, and consequently in which methods according to examples of the present disclosure may support the implementation and orchestration of ML models to optimise such RAN operations.

In some situations, a wireless device may have available multiple ML models for performing a single one of the above examples. In that situation, if the wireless device is not able to store all of the available ML models, the wireless device may determine which of these models should be stored, and which should be deleted. This determination may be based on criteria such as which of the models are more likely to be used in future.

In other situations, a wireless device may have available multiple ML models for performing respective different ones of the above examples. In that situation, if the wireless device is not able to store all of the available ML models, the wireless device may determine which of these models should be stored, and which should be deleted, and this determination may be based on criteria such as which of the models are more likely to provide significant gains in performance of the wireless device, based on some criteria.

As discussed in the present disclosure, the methods 100, 200 are performed by a wireless device, such as a UE, and the methods 300, 400 are performed by a RAN node. The present disclosure provides a wireless device and a RAN node that are adapted to perform any or all of the steps of the above discussed methods.

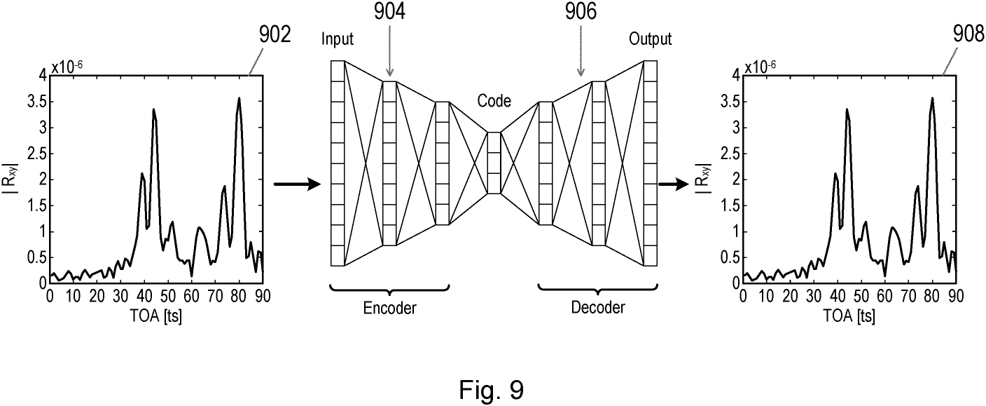

FIG. 11 is a block diagram illustrating an example wireless device 1100 which may implement the method 100 and/or 200 according to examples of the present disclosure, for example on receipt of suitable instructions from a computer program 1150. Referring to FIG. 11, the wireless device 1100 comprises a processor or processing circuitry 1102, and may comprise a memory 1104 and interfaces 1106. The processing circuitry 1102 is operable to perform some or all of the steps of the method 100 and/or 200 as discussed above with reference to FIGS. 1 and 2. The memory 1104 may contain instructions executable by the processing circuitry 1102 such that the wireless devoice 1100 is operable to perform some or all of the steps of the method 100 and/or 200. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive etc.

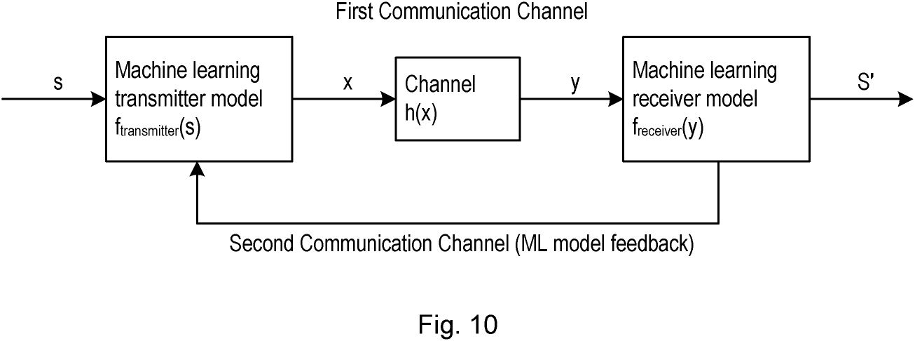

FIG. 12 illustrates functional modules in another example of wireless device 1200 which may execute examples of the methods 100 and/or 200 of the present disclosure, for example according to computer readable instructions received from a computer program. It will be understood that the modules illustrated in FIG. 12 are functional modules, and may be realised in any appropriate combination of hardware and/or software. The modules may comprise one or more processors and may be integrated to any degree.

Referring to FIG. 12, the wireless device 1200 is operable to connect to a communication network, wherein the communication network comprises a RAN. The wireless device 1200 comprises a determining module 1202 for determining which of a plurality of available ML models should be stored in the wireless device. The wireless device 1200 further comprises a storing module 1204 for, in response to determining that at least one of said available ML models should be stored in the wireless device, storing said at least one of said available ML models in a first memory in the wireless device. The wireless device 1200 further comprises a deleting module 1206 for, in response to determining that at least one of said available ML models should not be stored in the wireless device, deleting said at least one of said available ML models from the first memory in the wireless device. The wireless device 1200 may further comprise interfaces 1208.

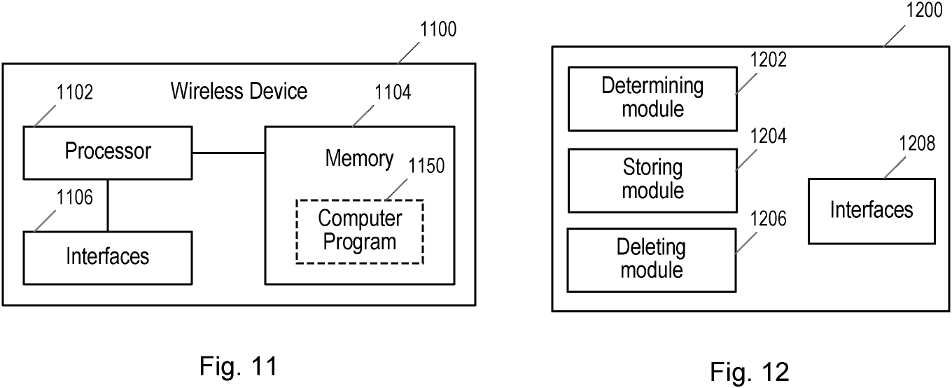

FIG. 13 is a block diagram illustrating an example RAN node 1300 which may implement the method 300 and/or 400 according to examples of the present disclosure, for example on receipt of suitable instructions from a computer program 1350. Referring to FIG. 13, the RAN node 1300 comprises a processor or processing circuitry 1302, and may comprise a memory 1304 and interfaces 1306. The processing circuitry 1302 is operable to perform some or all of the steps of the method 300 and/or 400 as discussed above with reference to FIGS. 3 and 4. The memory 1304 may contain instructions executable by the processing circuitry 1302 such that the RAN node 1300 is operable to perform some or all of the steps of the method 300 and/or 400. The instructions may also include instructions for executing one or more telecommunications and/or data communications protocols. The instructions may be stored in the form of the computer program 1350. In some examples, the processor or processing circuitry 1302 may include one or more microprocessors or microcontrollers, as well as other digital hardware, which may include digital signal processors (DSPs), special-purpose digital logic, etc. The processor or processing circuitry 1302 may be implemented by any type of integrated circuit, such as an Application Specific Integrated Circuit (ASIC), Field Programmable Gate Array (FPGA) etc. The memory 1304 may include one or several types of memory suitable for the processor, such as read-only memory (ROM), random-access memory, cache memory, flash memory devices, optical storage devices, solid state disk, hard disk drive etc.

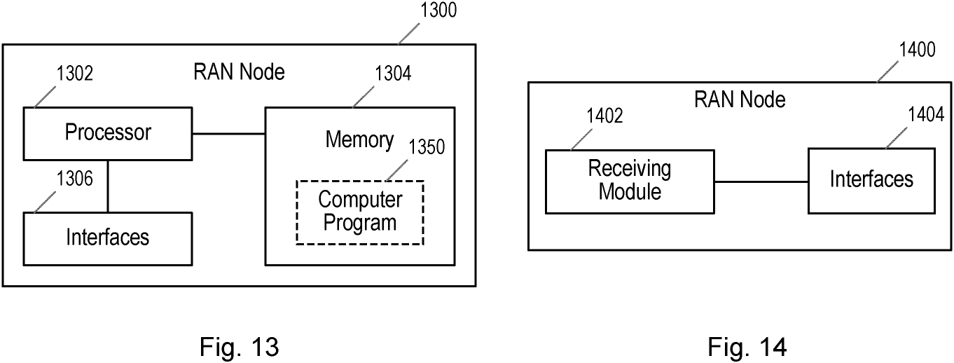

FIG. 14 illustrates functional modules in another example of RAN node 1400 which may execute examples of the methods 300 and/or 400 of the present disclosure, for example according to computer readable instructions received from a computer program. It will be understood that the modules illustrated in FIG. 14 are functional modules, and may be realised in any appropriate combination of hardware and/or software. The modules may comprise one or more processors and may be integrated to any degree.

Referring to FIG. 14, the RAN node 1400 is for managing a wireless device that is operable to connect to the communication network of which the RAN node is a part. The RAN node comprises a receiving module 1402 for receiving, from the wireless device, information identifying at least one Machine Learning, ML, model that is operable to provide an output on the basis of which at least one RAN operation performed by the wireless device, said information indicating that said at least one ML model has been deleted from a first memory in the wireless device. The RAN node may further comprise interfaces 1404.

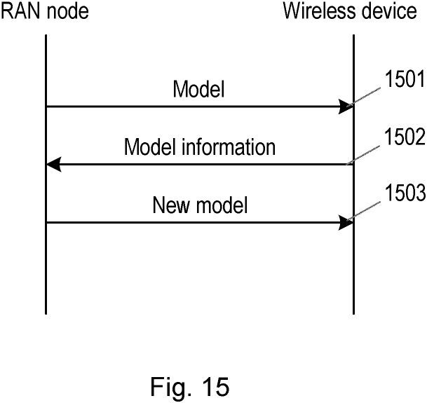

FIG. 15 is a signalling diagram illustrating an example signalling exchange that may take place during the performance of the methods 100, 200, 300 and/or 400. Referring to FIG. 15, first step 1501, a RAN node transmits a ML model to at least one wireless device, and requests the wireless device to report when the wireless device decides to delete that ML model or any other ML model.

At step 1502, the wireless device transmits to the RAN node information identifying one or more available ML model that it has decided to store and/or information identifying one or more available ML model that it has decided not to store in the first memory. This may also include information indicating a reason for storing said at least one ML model that it has decided to store, and/or information indicating a reason for deleting said at least one ML model that it has decided not to store.

Information elements in the message may thus allow the wireless device to signal some or all of: which model or models have been deleted, and the one or more associated radio feature(s); which model or models the UE has stored, and the associated radio feature; and which model is currently being executed, and the associated radio feature.

The wireless device can then also signal its new capabilities in:
the number of models in storage;
the available capacity of the wireless device to store models;
the available computational capacity of the wireless device for executing models; and/or
the radio features of the wireless device.

At step 1503, the RAN node sends a new ML model to the wireless device.

Aspects of the present disclosure, as demonstrated by the above discussion, provide methods, a RAN node and a wireless device that together may enable a wireless device to store ML models in an efficient way, so that it is able to make best use of ML models, without increasing memory requirements in the wireless device excessively.

Examples of the present disclosure may also improve energy efficiency of the network, for example by enabling a network node to reduce unnecessary signalling associated with sending unwanted ML models to wireless devices.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing a wireless device that is operable to connect to a communication network, wherein the communication network comprises a Radio Access Network, RAN, and wherein the wireless device has available for execution a plurality of Machine Learning, ML, models that are each operable to provide an output, on the basis of which at least one RAN operation performed by the wireless device may be configured, the method, performed by the wireless device, comprising:
determining which of said available ML models should be stored in the wireless device ;
in response to determining that at least one of said available ML models should be stored in the wireless device, storing said at least one of said available ML models in a first memory in the wireless device; and
in response to determining that at least one of said available ML models should not be stored in the wireless device, deleting said at least one of said available ML models from the first memory in the wireless device.

2. (canceled)

3. (canceled)

4. The method as claimed in claim 1, further comprising transmitting to at least one RAN node information identifying said at least one of said available ML models stored in the first memory in the wireless device.

5. The method as claimed in claim 4, further comprising transmitting to the at least one RAN node information indicating a reason for storing said at least one of said available ML models in the first memory in the wireless device.

6. The method as claimed in claim 1, further comprising transmitting to at least one RAN node information identifying said at least one of said available ML models deleted from the first memory in the wireless device.

7. The method as claimed in claim 6, further comprising transmitting to the at least one RAN node information indicating a reason for deleting said at least one of said available ML models from the first memory in the wireless device.

8. The method as claimed in claim 7, wherein the information indicating a reason for deleting said at least one of said available ML models from the first memory in the wireless device comprises an indication of a reason selected from a group comprising at least one of:
the ML model being too big;
the ML model performance being inadequate;
the ML model execution time being too long; and
the ML model battery consumption being too high.

9. The method as claimed in claim 1, further comprising, in response to determining that at least one of said available ML models should not be stored in the wireless device, storing said at least one of said available ML models in a second memory of the wireless device separate from the first memory of the wireless device .

10. The method as claimed in claim 1, comprising determining which of said available ML models should be stored in the wireless device based on a number of times that the wireless device has been in a specific area of the RAN.

11. The method as claimed in claim 1, comprising determining whether a specific one of said available ML models should be stored in the wireless device based on a number of times that the wireless device has been configured to use said specific one of said available ML models.

12. The method as claimed in claim 1, wherein the step of determining which of said available ML models should be stored in the wireless device comprises selecting a number of said available ML models that the wireless device has been configured to use most often.

13. (canceled)

14. (canceled)

15. The method as claimed in claim 1, comprising performing the step of determining which of said available ML models should be stored in the wireless device in response to one of:
determining that the first memory of the wireless device is full to a predetermined level;
being configured to receive a new model;
receiving an indication that one of said available ML models is outdated;
determining that a validity time associated with one of said available ML models has expired;
a change in a Radio Resource Control, RRC, state of the wireless device;
the wireless device handing over to a new RAN node; or
a change in a tracking area, operator, or country code.

16-24. (canceled)

25. A method for managing a wireless device that is operable to connect to a communication network, wherein the communication network comprises a Radio Access Network, RAN, the method, performed by a RAN node of the communication network, comprising:
receiving, from the wireless device, information identifying at least one Machine Learning, ML, model that is operable to provide an output on the basis of which at least one RAN operation performed by the wireless device may be configured, said information indicating that said at least one ML model has been deleted from a first memory in the wireless device .

26. The method as claimed in claim 25, further comprising receiving from the wireless device information indicating a reason for deleting said at least one ML model from the first memory in the wireless device.

27. The method as claimed in claim 26, wherein the information indicating a reason for deleting said at least one of said available ML models from the first memory in the wireless device comprises an indication of a reason selected from a group comprising at least one of:
the ML model being too big;
the ML model performance being inadequate;
the ML model execution time being too long; and
the ML model battery consumption being too high.

28. The method as claimed in claim 25, further comprising receiving, from the wireless device, information identifying at least one ML model that is operable to provide an output on the basis of which at least one RAN operation performed by the wireless device, said information indicating that said at least one ML model has been stored in the first memory in the wireless device.

29. (canceled)

30. The method as claimed in claim 25, further comprising, as initial steps:
sending an ML model to the wireless device; and
requesting the wireless device to inform the RAN node in the event that the ML model is deleted from the first memory in the wireless device.

31. The method as claimed in claim 25, further comprising, in response to receiving information identifying at least one ML model that has been deleted from the first memory in the wireless device, creating a new ML model based on the received information.

32. The method as claimed in claim 31, comprising creating the new ML model in response to receiving information from a number of wireless devices indicating that a specific ML model has been deleted from respective memories in the wireless devices, and wherein the number of wireless devices exceeds a threshold number.

33-35. (canceled)

36. A wireless device that is operable to connect to a communication network, wherein the communication network comprises a Radio Access Network, RAN, the wireless device comprising processing circuitry configured to cause the wireless device to:
determine which of a plurality of available ML models should be stored in the wireless device;
in response to determining that at least one of said available ML models should be stored in the wireless device, store said at least one of said available ML models in a first memory in the wireless device; and
in response to determining that at least one of said available ML models should not be stored in the wireless device, delete said at least one of said available ML models from the first memory in the wireless device.

37. (canceled)

38. A Radio Access Network, RAN, node of a communication network comprising a RAN, wherein the RAN node is for managing a wireless device that is operable to connect to the communication network, and wherein the RAN node comprises processing circuitry configured to cause the RAN node to:
receive, from the wireless device, information identifying at least one Machine Learning, ML, model that is operable to provide an output on the basis of which at least one RAN operation performed by the wireless device may be configured, said information indicating that said at least one ML model has been deleted from a first memory in the wireless device.

39. (canceled)
